(19) United States
(12) Patent Application Publication
(10) Pub. No.: US 2022/0132881 A1
(43) Pub. Date: May 5, 2022

(54) METHOD FOR PRODUCING GHEE

(71) Applicant: GEA MECHANICAL EQUIPMENT GMBH, Oelde (DE)

(72) Inventors: Carsten BRÄUTIGAM, Niederstotzingen (DE); Claus MATHIESEN, Rheda-Wiedenbrück (DE); Thomas VEER, Beesten (DE); Wolfgang GRUCHOT, Soest (DE)

(21) Appl. No.: 17/434,046

(22) PCT Filed: Feb. 27, 2020
(86) PCT No.: PCT/EP2020/055111

§ 371 Date: Aug. 26, 2021

(30) Foreign Application Priority Data
Feb. 27, 2019 (DE) 10 2019 104 917.2

(51) Int. Cl. A23D 9/02; A23C 15/04; A23C 15/14

(52) U.S. Cl. CPC A23D 9/02; A23C 15/14; A23C 15/04

(57) ABSTRACT

A method for producing ghee involves churning cream to form butter and buttermilk, which is melted and heated to a temperature of 45° C. and 90° C. Phase inversion by shearing is performed to form an oil, which is concentrated by centrifugal separation into an oil fraction and a serum fraction. The oil faction is boiled and at least one milk product is supplied. The boiled oil is clarified to produce ghee having a fat content of at least 99.0 wt. %.

### BACKGROUND AND SUMMARY OF THE INVENTION

Exemplary embodiments of the present invention relate to a method for producing ghee.

The basic principle of ghee production is the removal of moisture from butter or cream by heat. This produces heat-induced changes in the milk proteins, lactose, and solids-non-fat (SNF), which provide the typical ghee flavor. The ghee is then cooled and solid fat crystals form, floating in liquid fat. Several well-known ghee production methods are mentioned below, which are known as the desi method, direct-cream method, and prestratification method. The solids-non-fat can be determined by separating a sample, for example, by separating the fat and/or oil, for example, by an organic solvent and subsequent drying.

The Desi method is also called indigenous method or milk-and-butter method. It is the original method of ghee production. For this, cream is processed directly or fermented into butter. The butter is then melted over a fire and heated to 100-105° C. In this step, the product foams strongly. Proteins and impurities from the milk settle in the foam. In addition, precipitate is formed, which consists of the solids-non-fat and settles. Once most of the water has evaporated, foaming stops. The product then has a water content of about 1%. The temperature is increased to 115-120° C. The solids caramelize at these temperatures. In this last step, the aroma typical of ghee is created. As soon as the ghee turns golden yellow to brown, heating is stopped. The solids are then allowed to sediment. The clarified fat is then poured off and packaged, while the solids remain in the kettle.

In the direct-cream method, cream is processed directly into ghee. Since the butter-making step is omitted, this method is well suited for large production volumes. Possible starting materials are fresh or fermented cream. This is kept at 105° C. for several hours. During this process, the product foams strongly. Once most of the water has evaporated, the foaming subsides. Then the temperature is increased up to 115° C. and held until the ghee takes on a golden yellow to brown color. Then the heat-holding process is stopped. The ghee is clarified/filtered, packaged, and cooled.

The prestratification method (stratification, formation of strata) is also called the clarified-butter method or cream-butter method. This is suitable when a lot of butter is available and is used industrially, but can also be used for small production quantities.

Milk is separated into skim milk and cream. Butter is produced from the cream. This is melted at 80-85° C. It is then left to stand in a settling tank so that different layers form due to the differences in density. The upper layer consists of floating denatured proteins and impurities. The middle layer contains almost exclusively pure fat. The buttermilk serum collects in the bottom layer. The serum is drained off. The other two layers are heated together to 105-110° C. in a boiler heated with steam. The moisture evaporates and the flavor typical of ghee is produced.

The different types of ghee production have different advantages and disadvantages. Table 1 below lists the different production methods.

The main cause of fat loss is often the churning process. This explains why the direct-cream method has the lowest fat loss. Here, this process step is omitted. In addition, fat is lost with the boiling residue that occurs after heat clarification. Often the boiling residue is mixed with hot water to recover fat from it. A third point contributing to fat loss is intermediate storage and transfer to other containers. Here, residues remain in the containers, the proportions of which vary greatly.

TABLE 1
Comparison of the different ghee production methods

| Production | Production | | Storage | Fat |
|---|---|---|---|---|
| process | scale | Taste | stability | loss |
| Desi | Small | Characteristic | Bad | 15-25% |
| | | taste, full body | | |
| Direct Cream | Large-scale | Flat taste, better | Very | |
| | industrial | with aged butter | good | 5-10% |
| Prestratification | Large-scale | Flat taste, better | Good | 10-15% |
| | industrial | with aged butter | | |

The ghee made by the traditional desi method has the best taste and texture. That is why it is sold at high prices. However, the fat loss in this method is very high. Under the simplest conditions, it can be up to 30%, which is why this method is not used industrially. Desi ghee usually has a higher percentage of free fatty acids than ghee produced by the direct-cream or prestratification method (cf. Wadhwa, 2002, p. 151).

In the direct-cream method, the long boiling time is a limiting factor. There is still a very high moisture content in the cream, which must evaporate completely. Therefore, this production method is time and energy consuming. All non-fat ingredients are still present in the cream during the boiling process. Some sources report that due to this a particularly good taste is created, according to other sources this creates a strong caramelized taste, which is undesirable. To prevent this caramel taste, the use of cream with a fat content of 75-80% (so-called “plastic cream”) is recommended. The fat loss of the direct-cream method is 10-15%, which is much lower than that of the desi method. In general, ghee from the direct-cream method has a darker color.

The prestratification process is considered to save energy, time, and labor. Due to the fact that a large part of the water has already been separated from the product after the settling process, not so much moisture has to evaporate in the subsequent boiling process. As a result, 35-50% energy and up to 45% labor and time can be saved. Draining the buttermilk also results in less solids settling to the bottom of the kettle, which in turn results in less fat loss.

Ghee produced by the prestratification method generally has a relatively low free fatty acid content and a mild flavor. It is more perishable than ghee produced by the direct-cream method. The water content is nevertheless too low to allow microbial growth.

In general, there is no complete continuous process for the production of ghee today, which ensures a consistent quality of ghee and the possibility of producing different flavors. Weaknesses of the current processes are that they cannot standardize the SNF (Solids-non-fat) content necessary for boiling the oil. Thus, there is no process today where ghee is produced directly from cream without a churning process. The aim is to demonstrate that it is possible to produce ghee in a wide range of qualities by specifically adapting a butter oil process in order to combine the efficiency of the butter oil technology that already exists today with the ghee technology. A particularly interesting point is the serum dosage into the oil before or during the boiling process.

In the literature, it is often stated that ghee has a milk fat content of at least 99.6 wt. %. In the context of the method for a continuous ghee production described here, ghee is referred to as having a fat content of at least 99.0 wt. %.

Based on the foregoing, exemplary embodiments of the present invention are directed to a continuous method for the production of ghee having a high milk fat content of at least 99 wt. %.

The method according to the invention relates to the production of ghee. The method comprises the following steps:

a. Providing cream or milk, especially whole milk or raw milk;

Optionally, the milk can be converted into cream or processed directly into concentrated cream. Cream can also be used directly as a starting material.

b. Churning of cream with the formation of butter and buttermilk;

In a first method variant, cream is churned to form butter and buttermilk. However, the separated buttermilk contains flavoring substances, so-called SNF (solid-non-fat).

c. Melting the butter and heating the resulting oil to a temperature of 45 and 90° C.;

Melting of the butter can take place in a plate heat exchanger (PHE), in a tubular heater and/or a scraped heat exchanger.

d. Phase inversion by means of shearing;

The melting of the butter is followed by shearing. This can take place, for example, in a homogenizer or in a shear pump. The conditions of the shearing should be selected in such a way that a phase inversion preferably takes place. The phase-reversed melted butter, predominantly triglycerides, is referred to below as serum-containing oil.

e. Oil concentration by centrifugal separation of a serum fraction;

The oil or the melted butter is then concentrated. For this purpose, the so-called serum fraction, including minerals, vitamins, and/or lactose, is centrifugally separated from the melted butter.

f. Boiling the oil;

The concentrated oil is then boiled. Boiling can take place at temperatures between 100 and 130° C. Before this, the concentrated oil can be heated in a way that is gentle on the product.

g. Supplying at least one milk product;

In this step, buttermilk or serum fraction separated in the previous steps can be recycled back to the oil as a milk product. Alternatively, milk products can be added to the process from outside. Such milk products can be e.g., yogurt, acidified milk, but also serum or buttermilk. The milk products are necessary for the subsequent ghee-specific flavor formation. The additives themselves do not have to be the flavor-forming substances, but their products which are formed during the boiling in step f) by e.g., the Maillard reaction.

h. Clarifying the boiled intermediate product to provide ghee having a fat content of at least 99.0 wt. %.

Finally, the boiled oil is clarified. Production-related impurities, such as burnt or denatured components, are separated in the process. This provides industrially produced particle-reduced, preferably particle-free, ghee with an excellent taste and a very high fat content.

In an alternative second method variant, the production of ghee is carried out according to the preceding steps:
a. Providing cream or milk, especially whole milk or raw milk;
   This first method step can be carried out as in the first method variant.
b. Cream concentration to a cream with a fat content of 65-85 wt. %;
   In a second method step, the cream is concentrated to 65-85 wt. %. The concentration of milk to cream can be done in a single step in a machine, e.g., a separator.
c. Phase inversion by means of shearing;
   The phase is then reversed from a fat-in-water or oil-in-water emulsion to a water-in-fat or water-in-oil emulsion. This provides an oil with finely dispersed water droplets.
d. Concentrating oil by means of centrifugal separation of a serum fraction;
   Water is then separated from the oil or fat and subsequently boiled and clarified in the same way as in the first method variant.
e. Boiling the oil;
f. Supplying milk products or at least one milk product;
   In this step, skim milk, alpha-serum fraction or serum fraction separated in the previous steps can be recycled back to the oil as milk products. Alternatively, milk products can also be added to the process. Such milk products can be, for example, yogurt, acidified milk, but also externally supplied serum, alpha-serum, or buttermilk. The milk products may be flavoring agents or may form these flavoring agents during boiling. This results in the formation of ghee.
g. Clarification of the boiled intermediate to the final product ghee with reduced level of impurities, analogous to step h) of the previous process.

It is advantageous if in step a) cream is provided by a milk separation from 2-10 wt. % to 25-45 wt. % fat at a temperature of 4-65° C.

In step b), churning can be performed at a temperature of 8-20° C., preferably using a churning machine.

In step c), the melting of the butter may be performed in a plate heat exchanger, a tubular heater, and/or a scraped surface heat exchanger.

The melted butter in step c) can be fed to the separator via a container with agitator as an intermediate buffer before the oil concentration in step d).

The oil concentration in step d) or e) can be carried out with a separator.

Boiling in step e) or f) can be carried out in a product-friendly manner at a temperature between 100-130° C., preferably in a tube or boiling kettle.

Immediately before, during, or immediately after the boiling in step e) or f), milk products are added, e.g., as a dosage of milk serum, buttermilk, and/or milk-like liquid, such as yogurt residues, to adjust the SNF content in the oil. Here directly means that the dosage is the step e) directly downstream or upstream method step. This method step can preferably be carried out within less than 5 min before or after step e).

After boiling in step e) or f), sediment may be drained, preferably from the boiling kettle.

Cream concentration in step b) can be carried out at a temperature of 45-95° C.

The cream concentration in step b) can be carried out directly in one method step starting from milk with a fat content of 2-10 wt. % to cream with a fat content of 65-85 wt. %.

The shearing according to step c) or step d) can be carried out in a homogenizer and/or with a shear pump.

For oil concentration of phase-converted butter and/or phase-converted cream from 65 to max. 99.0 wt. % fat, a separator can preferably be used.

The addition of at least one milk product, in particular of previously separated skim milk, alpha serum, milk serum and/or buttermilk and/or of further milk products into the concentrated milk fat can preferably take place immediately before or during boiling in an amount of 0.5-10 wt. % to adjust a defined SNF content.

The dosage can be process-optimized by supplying milk serum, buttermilk, skim milk and/or alpha serum separated in the process.

The clarification in step g) or h) can advantageously be carried out by means of a centrifuge, e.g., by means of a 2-phase clarifier.

Steps a-h of the first method variant or a-g of the second method variant can preferably be carried out one after the other, wherein the execution of the steps takes place in a plant with several machine elements. The machine elements are interconnected to form a production line in such a way that the method steps a to f are carried out in the production line. The method is thus a so-called inline method.

In particular, no synthetic flavors are used during production, but rather only flavors of natural, preferably animal origin, especially dairy products.

Processing takes place as a continuous manufacturing process. A time-consuming batch process with a sequence of reaction containers, which are filled and completely emptied after the reaction and finally cleaned, is not provided. In a particularly preferred embodiment variant, a corresponding system for carrying out the continuous manufacturing process has so-called buffer containers which compensate for an irregular product supply. As a result, the product output is continuous and not intermittent.

The intermediate products produced in the present method preferably have a milk fat content of less than 99.0 wt. %. Thus, the intermediate product produced is not a high-quality butter oil or anhydrous milk fat (AMF), but a product with a lower fat content. Accordingly, the process requirements are reduced.

### BRIEF DESCRIPTION OF THE DRAWING FIGURES

Further advantages, features and details of the invention will be apparent from the following description, in which several exemplary embodiments of the invention are explained in more detail with reference to the accompanying drawings. The person skilled in the art will conveniently also consider the features disclosed in combination in the drawings, the description, and the claims individually and combine them to form useful further combinations, wherein:

FIG. 1 shows a flow diagram for a first variant of a method according to the invention for the production of ghee starting from cream; and

FIG. 2 shows a flow diagram for a second variant of a method according to the invention for the production of ghee starting from whole milk.

### DETAILED DESCRIPTION

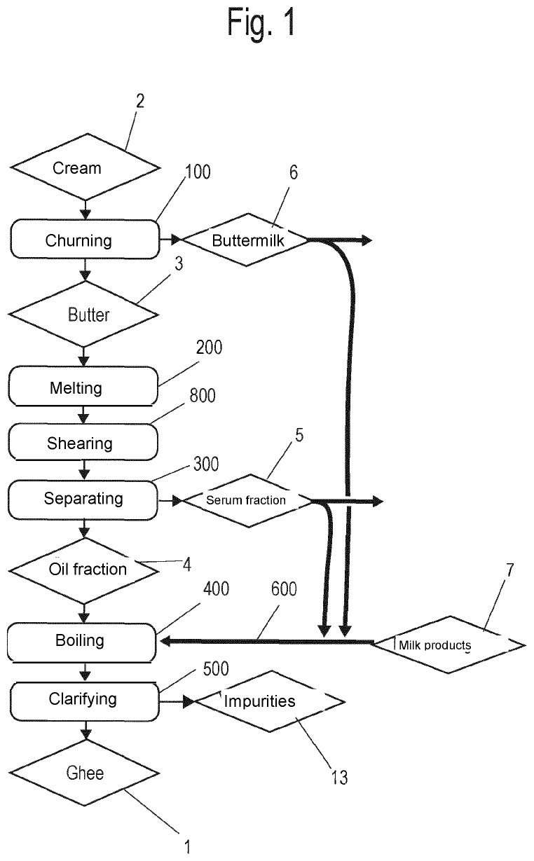

FIG. 1 shows a first method variant for the production of ghee 1. The starting material in the production is cream 2. However, an intermediate product mentioned below, such as butter 3, can also be used as a starting material.

Cream 2 typically comprises fat from 25 to 45 wt. %.

The cream 2 is first divided into butter 3 and buttermilk 6 in a churning process 100. Butter 3 has a fat content of 70 to 85 wt. %. The butter 3 is then processed further.

The butter is then melted at a temperature of between 45-90° C., ideally between 55-65° C. The melted butter is then fed inline or via a feed tank with agitator to a device for shearing the melted butter, preferably a homogenizer. In method step 800, the molten butter can then be sheared with phase transformation.

The serum-containing oil fraction thus obtained can be fed to a separator for centrifugal separation 300. In particular, the separator may be a disk separator. The terms oil and oil fraction are used synonymously in the context of the present invention.

In separation 300, the phase-converted melted butter 3, or serum-containing oil, is separated into an oil fraction 4 and a serum fraction 5. The oil fraction 4 contains between 65- to less than 99.0 wt. % fat and the serum fraction 5 between 0.5-50 wt. % fat and a high proportion of SNF (solids-non-fat).

The oil fraction 4 can be further heated up to 100° C. The terms “oil” and “oil fraction” are used synonymously in the context of the present invention.

In a subsequent boiling process 400, residual water is evaporated at a temperature between 100-130° C. and the SNF particles are boiled in a defined way, so that a specific coloration and flavor formation occurs.

In order to ensure a consistent quality of the final product, i.e., the milk fat/ghee 1 or to adapt it to different tastes, it is possible to add buttermilk 6 and/or serum fraction 5 or other milk products 7 in a concentration of 0.5-10 wt. % to the oil fraction 4 before or during boiling 400 by admixing or feeding 600.

Thus, a defined SNF content can be set, which influences the color and flavor formation. The more SNF is contained in oil fraction 4, the more color or flavor formation is perceptible in terms of taste. At this point, the flavor-enriched oil can already be called ghee.

After the boiling process 400, which can last between 30-180 min, the sediment produced during boiling is drained from the boiling kettle.

Then the clarification 500 of the milk fat is carried out by means of a filtration and/or a sieving device and/or a centrifuge, preferably a 2-phase separator, with separation of impurities 13, e.g., burnt or denatured ingredients. It is also possible to clarify the ghee directly without draining the solids.

After clarification, ghee with a fat content of at least 99.0 wt. % is then available.

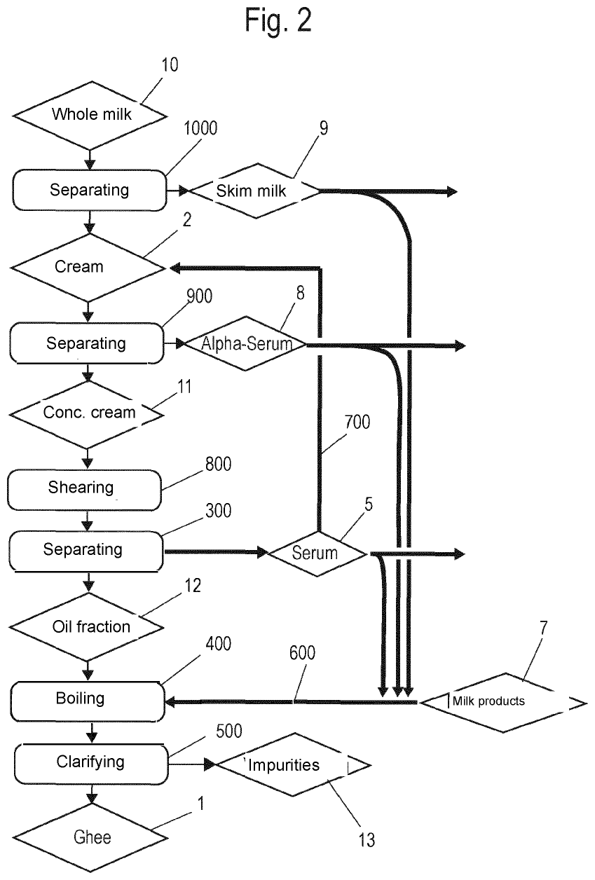

FIG. 2 shows a method variant of the method according to the invention. In this case, the starting material for the production of ghee 1 with a high milk fat content of at least 99.0 wt. % is whole milk 10 or alternatively raw milk. This has a milk fat content of between 2-10 wt. % fat. In a separation process 1000, for example in a centrifugal separation process, the whole milk or raw milk is concentrated to form cream 2 with a fat content of 25-45 wt. % fat. This separation 1000 takes place at a temperature between 4-65° C. with separation of skim milk 9.

The resulting cream 2 is further concentrated by a further separation 900, preferably by means of a centrifugal separator, to a fat content of 65-85 wt. % fat with separation of a first heavy phase 8, the alpha serum. The highly concentrated cream 11 is converted from a fat-in-water emulsion to a water-in-fat emulsion by means of shearing 800, preferably in a homogenizer and/or by a shear pump. The resulting oil is then subjected to a separation process 300 inline or via a feed tank with agitator.

There, the phase-converted cream is divided into an oil fraction 12 and a serum fraction 5. The oil fraction contains between 65- to less than 99.0 wt. % fat and the serum fraction between 0.5-50 wt. % fat and a high proportion of SNF (solids-non-fat). The serum fraction 5 can be introduced into the cream by recycling 700 preferably.

The oil fraction 12 can then be further heated up to 100° C. In a subsequent boiling process 400, residual water is evaporated at a temperature between 100-130° C. and the SNF particles are boiled in a defined manner so that specific coloring and flavor formation occurs.

In order to ensure a consistent quality of the final product, i.e., a high-fat ghee 1, and/or to adapt it to different tastes, it is possible to add previously separated alpha serum 8 and/or serum 5 or another milk product 7 in a concentration of 0.5-10 wt. % to the oil fraction 12 before or during boiling 400 by admixing 600.

Thus, a defined SNF content can be set, which influences the color and flavor formation. The higher the SNF content, the more color and flavor formation occurs.

After the boiling process 400, which may last between 30-180 min, the sediment formed during boiling is drained from the boiling kettle. Then the clarification 500 of the milk fat is carried out with separation of impurities 13, in particular solids, by means of a filtration and/or sieving device and/or by means of a centrifuge, preferably a 2-phase separator. It is also possible without draining the solids to directly clarify the fraction to the final product, the ghee 1.

After clarification, ghee 1, having a fat content of at least 99.0 wt. % fat, is then present.

Since clarifiers (2-phase separator) are currently used for the ghee process and 3-phase separators are used as polishing stage for the butter oil process, a 3-phase separator can also be used for clarification in the ghee process to increase the flexibility of the process design. In this case, the heavy phase can be returned to the feed, while in the production of butter oil/AMF, the heavy phase is fed out of the process.

Thus, it is possible to polish butter oil/AMF as well as clarify ghee with one machine. In this way, both products can be produced with one process line without having to purchase a second type of machine.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE NUMERALS

1 Ghee
2 Cream
3 Butter
4 Oil fraction
5 Serum fraction
6 Buttermilk
7 Dairy products
8 Alpha Serum
9 Skim milk
10 Whole milk
11 Concentrated cream
12 Oil fraction
13 Impurities
100 Churning
200 Melting
300 Separating
400 Boiling
500 Clarifying
600 Admixing/feeding
700 Recycling
800 Shearing
900 Separating
1000 Separating

1-17. (canceled)

18. A method for producing ghee, the method comprising:
a. providing cream;
b. churning the cream to form butter and buttermilk;
c. melting the butter and heating the melted butter to a temperature of 45 and 90° C.;
d. performing phase inversion of the melted butter by shearing to form a serum-containing oil;
e. concentrating the serum-containing oil by centrifugal separation into an oil fraction as an intermediate product having a milk fat content less than 99.0 wt. % and a serum fraction;
f. boiling the oil faction;
g. supplying at least one milk product to the oil faction; and
h. clarifying the boiled oil faction with the at least one milk product to produce ghee having a fat content of at least 99.0 wt. %.

19. The method of claim 18, wherein the provision of cream in step a) involves providing whole or raw milk having 2-10 wt. % fat to cream and separating the whole or raw milk at a temperature of 4-65° C. to form the cream, which has 25-45 wt. % fat.

20. The method of claim 18, wherein in step b) the churning is performed by a churning machine at a temperature of 8-20° C.

21. The method of claim 18, wherein step c) the melting of the butter takes place in a plate heat exchanger, a tube heater, or a scraped heat exchanger.

22. The method of claim 18, wherein the butter melted in step c) is fed to the shearing in step d) via a container with agitator as intermediate buffer.

23. The method of claim 18, wherein the boiling in step e) is performed in a tube or a boiling kettle at a temperature between 100-130° C.

24. The method of claim 18, wherein immediately before, during, or immediately after the concentrating in step e) or the boiling in f), the at least one milk product is supplied to adjust solids-non-fat content, wherein the at least one milk product is a serum fraction, buttermilk, skim milk, alpha-serum, yogurt, or acidified milk.

25. The method of claim 18, wherein after concentrating in step e) or boiling in f), sediment is drained from a boiling kettle.

26. The method of claim 18, wherein the supplying of the at least one milk product is performed immediately before or during the boiling of the oil faction with an amount of 0.5-10 wt. % of the at least one milk product to set a defined solids-non-fat content, wherein the at least one milk product is previously separated skim milk, alpha serum, serum fraction, buttermilk, or of one or more further milk products.

27. The method of claim 26, wherein supplying the at least one milk product involves feeding serum fraction, buttermilk, skim milk, or alpha serum, which is previously separated by the steps of the method.

28. The method of claim 18, wherein the clarification in step h) is performed by a centrifuge.

29. The method of claim 18, wherein the steps a-g or a-h are performed successively, wherein execution of the steps is performed in a plant having a plurality of machine elements, wherein the plurality of machine elements are connected to one another to form a production line, such that the method steps a-g or a-h are carried out in the production line.

30. A method for producing ghee, the method comprising:
a. providing cream;
b. concentrating the cream to form a concentrated cream having a fat content of 65-85 wt. %;
c. performing phase inversion of concentrated cream by shearing to form a serum-containing oil;
d. concentrating the serum-containing oil by centrifugal separation into an oil fraction as an intermediate product having a milk fat content of less than 99.0 wt. % and a serum fraction;
e. boiling the oil faction;
f. supplying at least one milk product to the oil faction; and
g. clarifying the boiled oil with the at least one milk product to produce ghee having a fat content of at least 99.0 wt. %.

31. The method of claim 30, wherein the provision of cream in step a) involves providing whole or raw milk having 2-10 wt. % fat to cream and separating the whole or raw milk at a temperature of 4-65° C. to form the cream, which has 25-45 wt. % fat.

32. The method of claim 30, wherein the boiling in step e) is performed in a tube or a boiling kettle at a temperature between 100-130° C.

33. The method of claim 30, wherein immediately before, during, or immediately after the concentrating in step e) or the boiling in f), the at least one milk product is supplied to adjust solids-non-fat content, wherein the at least one milk product is a serum fraction, buttermilk, skim milk, alpha-serum, yogurt, or acidified milk.

34. The method of claim 30, wherein after concentrating in step e) or boiling in f), sediment is drained from a boiling kettle.

35. The method of claim 30, wherein the concentration of the cream in step b) is performed at a temperature of 45-95° C.

36. The method of claim 30, wherein the concentration of the cream in step b) is performed starting from milk with a fat content of 2-10 wt. % to cream having a fat content of 65-85 wt. %.

37. The method of claim 30, wherein the shearing of step c) is performed by a homogenizer or a shear pump.

38. The method of claim 30, wherein the supplying of the at least one milk product is performed immediately before or during the boiling of the oil faction with an amount of 0.5-10 wt. % of the at least one milk product to set a defined solids-non-fat content, wherein the at least one milk product is previously separated skim milk, alpha serum, serum fraction, buttermilk, or of one or more further milk products.

39. The method of claim 38, wherein supplying the at least one milk product involves feeding serum fraction, buttermilk, skim milk, or alpha serum, which is previously separated by the steps of the method.

40. The method of claim 30, wherein the clarification in step h) is performed by a centrifuge.

41. The method of claim 30, wherein the steps a-g or a-h are performed successively, wherein execution of the steps is performed in a plant having a plurality of machine elements, wherein the plurality of machine elements are connected to one another to form a production line, such that the method steps a-g or a-h are carried out in the production line.
